(19) United States
(12) Patent Application Publication
(10) Pub. No.: US 2010/0327241 A1
(43) Pub. Date: Dec. 30, 2010

(54) JACKING COLUMN FOR CONCRETE DRILLING AND CUTTING

(75) Inventor: Anders E. T. Johnsen, Borlange (SE)

Correspondence Address: Hovey Williams LLP, 10801 Mastin Blvd., Suite 1000, Overland Park, KS, 66210, US

(73) Assignee: TRACTIVE AB, Borlange (SE)

(21) Appl. No.: 12/491,500

(22) Filed: Jun. 25, 2009

(51) Int. Cl. B66F 3/16

(52) U.S. Cl. 254/85

(57) ABSTRACT

An adjustable length jacking column for supporting a cutting or drilling tool between spaced apart surfaces is disclosed. A speed drive serves to quickly adjust the column sections to an intermediate position closely corresponding to the distance between the spaced apart surfaces. A selectively engageable screw drive is configured to shift the column sections from the intermediate position to a secured position, in which the column length corresponds to fixed securement between the surfaces. The screw drive is drivingly connected between the column sections to shift the column sections relative to one another when engaged, and is drivingly disconnected from at least one of the column sections when disengaged so as to avoid interfering with relative shifting of the column sections by the speed drive.

### BACKGROUND OF THE INVENTION

1. Field of the Invention

The present invention relates generally to an extendable column for supporting drilling and cutting equipment between spaced apart surfaces. More particularly, the present invention concerns a column utilizing a screw drive for reliably securing the column in place.

2. Discussion of the Prior Art

In cutting and drilling operations, one or more columns are commonly secured between spaced surfaces (e.g., the floor and ceiling of a structure) to support the cutting or drilling tool (e.g., a circular sawing machine, a chain or wire saw, a boring tool, etc.) during operation thereof. It is important that the column firmly support the tool so that unintended tool movement is avoided. This becomes of greater significance in concrete cutting and drilling operations, as the column has to counteract the significant operational loads experienced by the tool. Low cost precision cutting and drilling requirements have only further increased the need for columns that can be quickly and securely installed without sacrificing safety.

Conventional tool-supporting columns suffer from various problems and fail to address these problems. For example, installation of conventional columns is time consuming and therefore expensive. Conventional columns often utilize a design that is complicated and/or unable to reliably withstand significant operational loads.

### SUMMARY

According to one aspect of the present invention, the jacking column includes a pair of shiftably interconnected column sections that permit adjustment of the overall column length so that the column is fixedly securable between spaced apart surfaces. The column further includes a tool support operable to support a cutting or drilling tool at various positions along the length of the column. A speed drive is coupled between the column sections to rapidly shift the column sections relative to one another to an intermediate position. The column also includes a selectively engageable screw drive configured to shift the column sections from the intermediate position to a secured position, in which the column length corresponds to fixed securement between the surfaces. The screw drive is drivingly connected between the column sections to shift the column sections relative to one another when engaged, and is drivingly disconnected from at least one of the column sections when disengaged so as to avoid interfering with relative shifting of the column sections by the speed drive. The screw drive includes a threaded shaft associated with one of the column sections and a threaded body associated with the other of the column sections, such that relative rotation of the shaft and body causes relative shifting of the column sections when the screw drive is engaged.

For example, in cutting or drilling operations where the jacking column is secured between the floor and ceiling of a structure, the operator uses the speed drive to quickly extend the column to a length closely corresponding to the distance between the floor and ceiling. Once the column sections reach this intermediate position, the screw drive is engaged and operated to shift the columns to the secured position, wherein the column is wedged securely between the floor and ceiling. The screw drive is capable of withstanding significant loads (e.g., several tons of force), while reducing the risk of unintended relative shifting of the column sections (i.e., retraction of the column). Accordingly, the column is quickly and securely installed.

This summary is provided to introduce a selection of concepts in a simplified form that are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a perspective view of a jacking column constructed in accordance with a preferred embodiment of the present invention, depicting the column secured between the floor and ceiling of a structure to support a concrete boring tool during drilling operations;

FIG. 2 is a perspective view of the jacking column depicted in FIG. 1, but taken from a different angle;

FIG. 3 is an enlarged fragmentary view of the jacking column and tool depicted in FIG. 1, particularly showing the manner in which the tool is mounted on the column;

FIG. 4 is a fragmentary perspective view of the jacking column that is cross-sectioned to depict the lower portion of the column and, more particularly, components of the speed drive, the screw drive, and the clamp assembly;

FIG. 5 is a fragmentary perspective view of the jacking column that is cross-sectioned to depict components of the speed drive, screw drive, and the clamp assembly;

FIG. 6 is a fragmentary cross-sectional view of the jacking column, specifically showing components of the speed drive, screw drive, and the clamp assembly;

FIG. 7 is an exploded perspective view of the screw drive, a lock bushing, and an inner tube of the screw drive;

FIG. 8 is a fragmentary perspective view of the jacking column, particularly illustrating the clamp assembly and the pinion gear components of the speed drive;

FIG. 9 is a greatly enlarged fragmentary perspective view of the jacking column, depicting the clamp assembly, the lower portion of the tool support, and the inserted lock bolt to engage the screw drive; and

FIG. 10 is a plan view of the jacking column with the middle portion being broken away, specifically showing the column connected between an exemplary mounting base and mounting pad to facilitate securement of the column between the surfaces.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

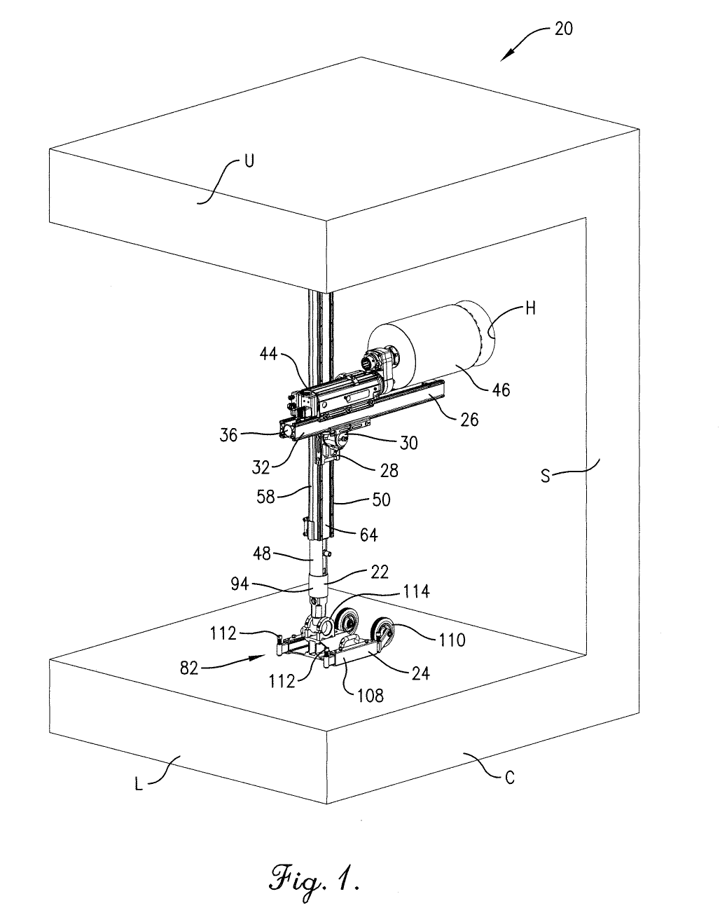

Initially referring to FIGS. 1-3, a drilling and cutting assembly 20 is illustrated for use in drilling a hole H in a concrete structure C. However, the assembly 20 is configured for various drilling and cutting operations in structure C, particularly where large static compression loads (often in excess of several tons) and dynamic loads are generated in securing the assembly 20 and conducting the drilling or cutting operation. The structure C includes parallel upper and lower walls U,L and sidewall S. As will be discussed further, the assembly 20 is secured in an upright orientation between upper and lower walls U,L to provide a stable platform for drilling of the sidewall S. However, the principles of the present invention are applicable where the assembly 20 is secured to an alternatively shaped structure, e.g. where the walls U,L are not parallel to each other. Furthermore, it is also within the ambit of the present invention where the assembly 20 is secured to a structure other than concrete, such as steel, stone, or wood, or is used to cut or drill into such alternative structures. The assembly 20 may also be installed in various other orientations, such as an angled or horizontal orientation. The assembly 20 broadly includes a jacking column assembly 22, a wheeled mounting base 24, and a drill assembly 26.

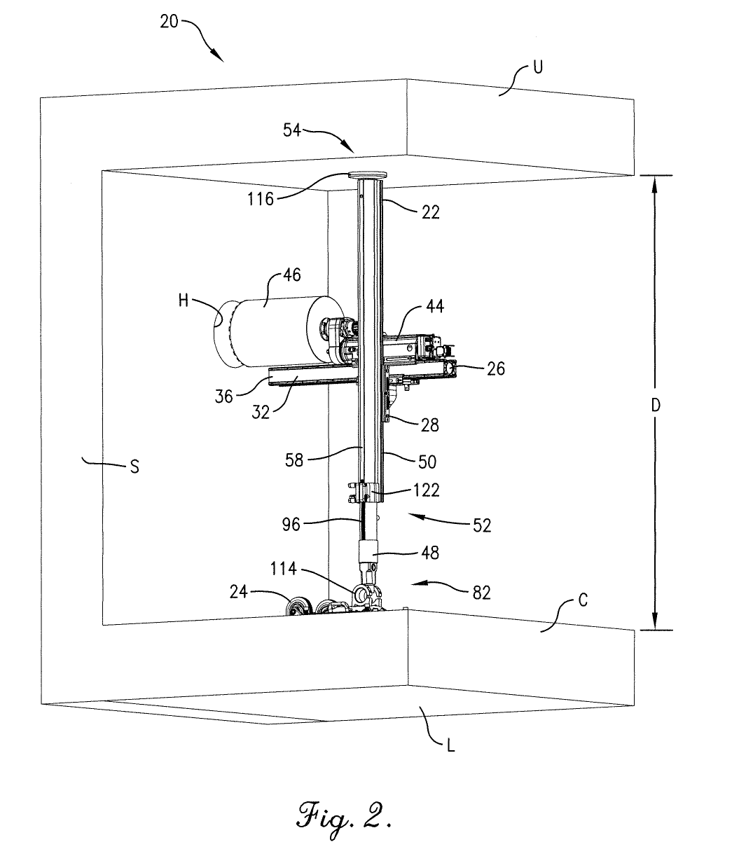

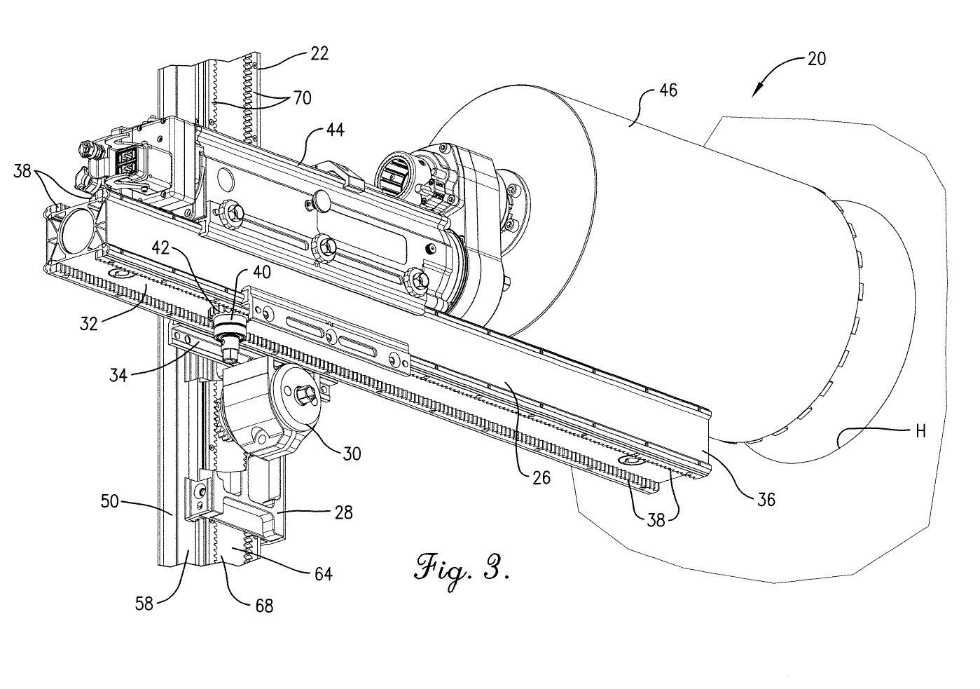

Turning to FIGS. 2 and 3, the drill assembly 26 is operable to cut the hole H through structure C. However, it is within the scope of the present invention where an alternative tool, i.e., another drill or saw, is used to cut or drill into the structure C. Again, the drill assembly 26 could also be used or configured to drill into materials other than the concrete structure C. The drill assembly 26 includes a slidable support 28 that is slidably mounted on the jacking column assembly 22, as will be discussed further, and an outer column drive 30 mounted on the slidable support 28. The outer column drive 30 drivingly engages the jacking column assembly 22 to shift the drill assembly 26 along the length of the jacking column assembly 22 (i.e., along a longitudinal axis of the jacking column assembly 22).

The drill assembly 26 further includes a transverse rail 32 slidably mounted to a transverse support 34, with the transverse support 34 being mounted on the slidable support 28. Thus, the rail 32 is slidable along an axis substantially perpendicular to the column axis to shift the drill assembly transversely relative to the column axis. The rail 32 includes a beam 36 and pairs of racks 38 mounted on opposite faces of the beam 36. The drill assembly 26 also includes a transverse drive 40 with a rotatable spur gear 42 that drivingly intermeshes with a corresponding rack 38. Thus, rotation of the spur gear 42 causes linear transverse movement of the rail 32 relative to the jacking column assembly 22.

The drill assembly 26 also includes a conventional drill 44 that is slidably mounted on the rail 32. The illustrated drill 44 includes a drill body and, in the usual manner, is drivingly attached to a hole saw 46. However, it is also within the scope of the present invention where an alternative drill bit, blade, or rotary attachment is used to cut an opening in structure C. Again, the principles of the present invention are also applicable where another type of drilling or cutting tool is supported by the assembly 20. The drill 44 includes a mechanism (not shown) that drivingly engages at least one of the racks 38 on a side of the beam 36 opposite the transverse drive 40 to selectively shift the drill 44 relative to the rail 32 along the transverse axis. The illustrated drill assembly 26 preferably provides two-axis positioning of the drill 44 relative to the jacking column assembly 22. However, it is equally within the scope of the present invention where an alternative support structure is used to adjustably mount the drill 44 to the jacking column assembly 22 and provide the two-axis positioning of the drill 44.

Turning to FIGS. 2 and 4-10, the jacking column assembly 22 serves to position and secure the drill 44 for cutting of the hole H. As will be discussed in greater detail, the jacking column assembly 22 includes a column comprising shiftable inner and outer column sections 48,50 that shift relative to each other to determine a length of the jacking column assembly 22. Furthermore, the jacking column assembly 22 includes an advantageous drive system for quickly adjusting the column length and securing the column assembly 22 to the structure C. While the illustrated assembly 20 includes a single jacking column assembly 22, it is also within the scope of the present invention where multiple jacking column assemblies 22 are stacked end-to-end to cooperatively provide a column that supports the drill 44. It is also possible for the column assemblies to have various lengths.

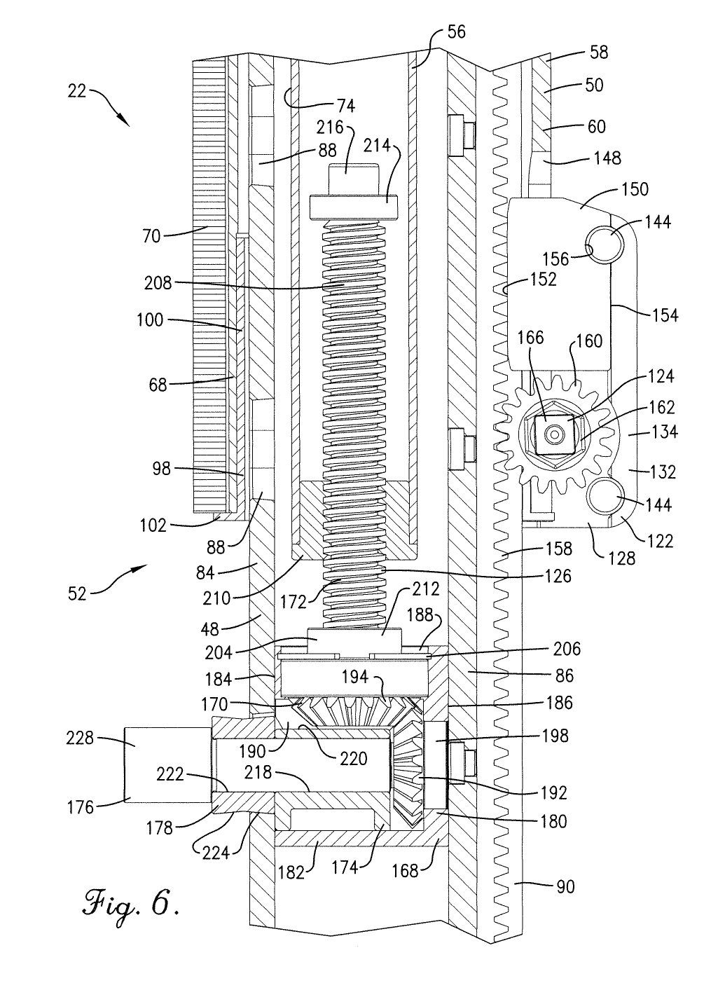

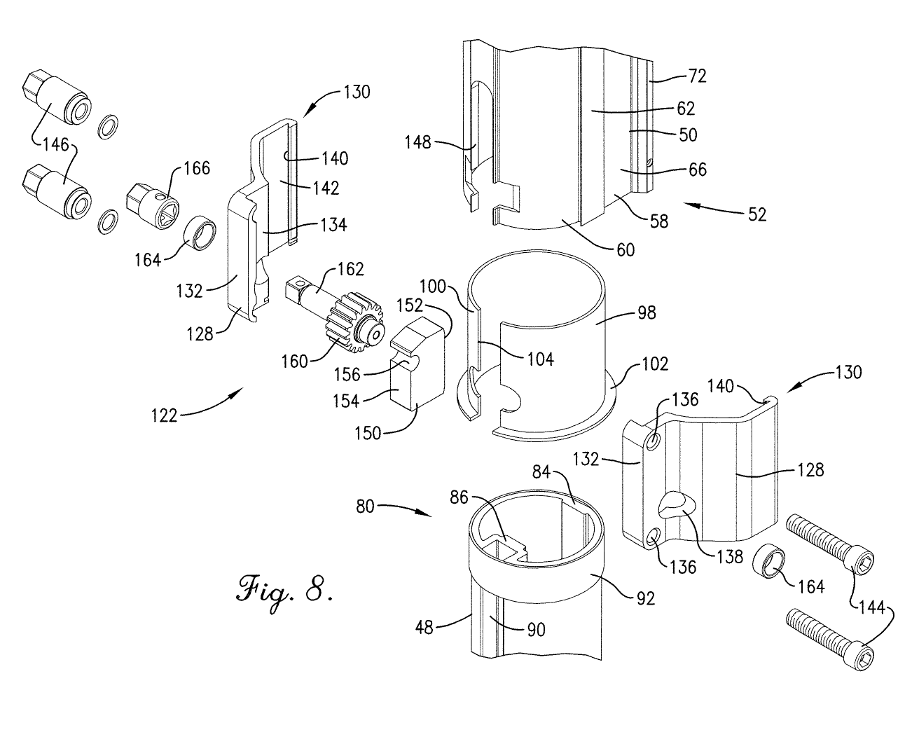

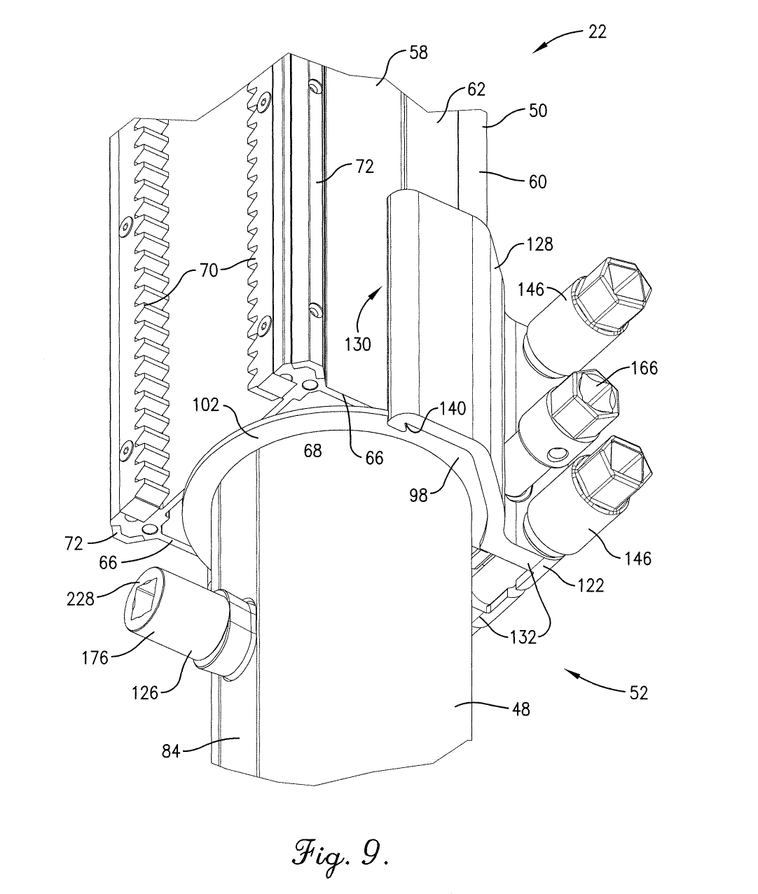

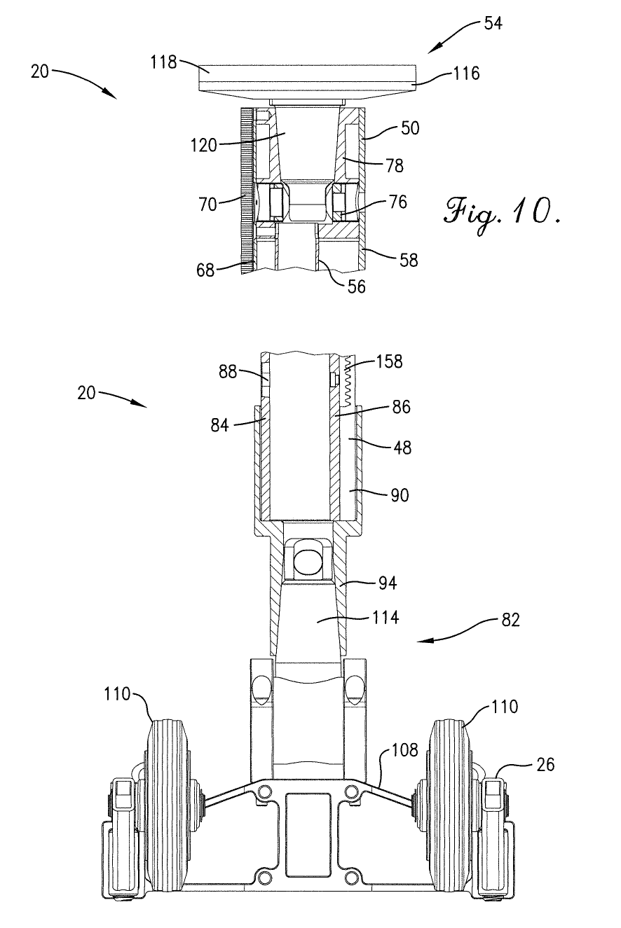

Again, the jacking column assembly 22 includes inner and outer column sections 48,50 that are preferably telescopically interfitted with each other to adjust the column length. The principles of the present invention are also applicable to column sections that are otherwise suitably interconnected for relative axial shifting. The outer column section 50 presents inboard and outboard ends 52,54 (see FIGS. 8 and 10), with an inner tube 56 extending between the ends 52,54 (see FIGS.6 and 10). Furthermore, the outer column section includes an outertube 58 that also extends between the ends 52,54. The outer tube 58 comprises a unitary construction with a generally cylindrical wall 60, laterally projecting ribs 62 on opposite sides of the wall 60, and a tool support 64 projecting radially outwardly from the wall 60 and spaced between the ribs 62; with the wall 60, ribs 62, and tool support 64 being preferably integrally formed and presenting a substantially uniform cross-section along the length of the outer tube 58 (see FIGS. 8 and 9).

Turning to FIG. 9, the tool support 64 is preferably in the form of an elongated rail including a continuous wall that presents a cross-section with opposite sidewall segments 66 joined by a perpendicular interconnecting wall segment 68 at respective corners of the tool support 64. The tool support 64 also includes opposed toothed racks 70 attached adjacent to respective corners of the tool support 64. Furthermore, the tool support 64 includes opposite elongated bushings 72 attached adjacent to and located outboard of the racks 70. Thus, the tool support 64 provides a tool support that preferably extends continuously along the length of the outer column section 50. However, the principles of the present invention are applicable where the outer column section 50 is alternatively configured to support the drill 44 and permit adjustable positioning of the drill 44 along the column axis. For instance, the outer column section 50 could include multiple discrete mounting locations spaced along the column axis.

Turning to FIGS. 6 and 10, the inner tube 56 comprises a unitary tube structure spaced within the outer tube 58, with the tubes 56,58 cooperatively presenting an annular chamber 74 for receiving the inner column section 48 in telescopic engagement, as will be discussed further. The tubes 56,58 are interconnected at the outboard end 54 by a coupling assembly 76 that includes a female tapered coupling 78 (see FIG. 10). The coupling 78 is received by and secured within the outer tube 58 and is attached to the inner tube 56.

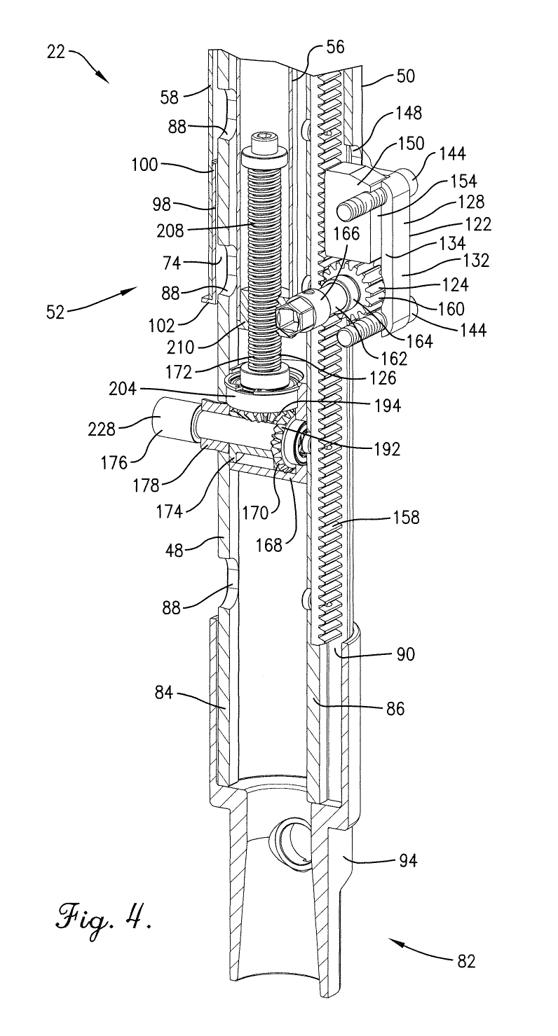

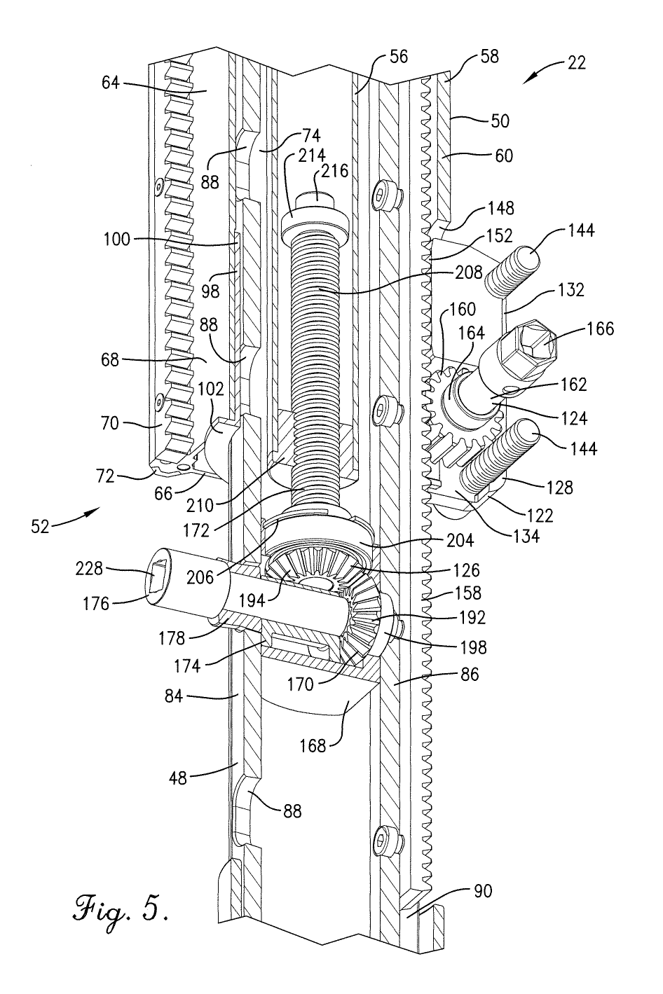

Turning now to FIGS. 4-6,8, and 10, the inner column section 48 presents inboard and outboard ends 80,82 and includes a tube extending between the ends 80,82 (see FIGS. 8 and 10). The tube presents a substantially circular cross-section with a flat wall portion 84 and a channel portion 86 that are oppositely spaced and extend longitudinally along the column axis (see FIG. 8). The flat wall portion 84 presents a plurality of spaced apart oblong locating holes 88 for securing the column sections 48,50 to each other. As will be discussed, the locating holes 88 each present an inner face that tapers in a radially outward direction from the column axis. The channel portion 86 presents a slot 90 with an open face. The inner column section 48 also includes a collar 92 attached to the inboard end 80 (see FIG. 8) and a female tapered coupling 94 attached to the outboard end 82 (see FIG. 10). The inner column section 48 receives a continuous rack, as will be discussed further. The rack is secured in the slot 90 and has multiple teeth facing outwardly from the slot 90 (see FIGS. 4 and 5).

Turning to FIGS. 6 and 8, the column sections 48,50 are slidably attached to each other by inserting the inner column section 48 through a split bushing 98. The split bushing 98 is substantially unitary and includes an arcuate wall 100 with a flange 102 at one end of the bushing 98. The bushing 98 also presents a slot 104 that preferably extends entirely from the flanged end to the opposite straight end of the bushing 98 (see FIG. 8). The wall 100 presents an inner cylindrical diameter that is dimensioned to slidably receive the inner column section 48, with the collar 92 configured to engage the straight end of the bushing 98 and restrict the inner column section 48 from sliding entirely out of the bushing 98.

The inboard end 80 of the inner column section 48 and the split bushing 98 are inserted into the inboard end 52 of the outer column section 50 and into the annular chamber 74 (see FIG. 6). The split bushing 98 is inserted until the flange 102 engages the inboard end 52. Thus, the column sections 48,50 are preferably telescopically interfitted with each other. However, the principles of the present invention are applicable where column sections 48,50 form an alternative slidable connection (e.g., the column sections 48,50 may directly slidably contact one another so that the bushing 98 is unnecessary). As will be discussed further, the slidable connection between column sections 48,50 permits continuous adjustment of column length.

As will be discussed further, the outboard end 82 of inner column section 48 is attached to the wheeled mounting base 24 for stably anchoring a lower end of the jacking column assembly 22 to a lower surface of the structure C. The mounting base 24 includes a body 108, wheels 110 rotatably mounted to the body 108 alongside one another, adjustable mounting screws 112 threaded into the body 108, and a male coupling 114 pivotally mounted at a central pivot location to the body 108. The male coupling 114 presents a male tapered surface that is dimensioned to be received by a complementally shaped female tapered surface of the female tapered coupling 94. Additional features of a similar male and female tapered coupling are disclosed in U.S. Pat. No. 4,500,235, issued Feb. 19, 1985, entitled COUPLING, which is hereby incorporated in its entirety by reference herein.

The outboard end 54 of the outer column section 50 is attached to amounting pad 116 for anchoring an upper end of the jacking column assembly 22 to wall U of structure C. The mounting pad 116 includes a flat plate 118 and an integral male coupling 120. The male coupling 120 presents a male tapered surface that is dimensioned to be received by a complementally shaped female tapered surface of the tapered coupling 78. Again, features of a similar male and female tapered coupling are disclosed in the above-incorporated U.S. Patent.

Thus, the wheeled mounting base 24 and mounting pad 116 serve to frictionally interconnect ends of the jacking column assembly 22 and the structure C, particularly as the jacking column assembly 22 is placed under compression. Although the mounting base 24 and mounting pad 116 are depicted as mounting the assembly 20 between substantially parallel surfaces of structure C, the pivotal joint of the mounting base 24 also permits mounting between surfaces that are not parallel. While the illustrated assembly 20 is mounted in a vertical orientation where the column extends vertically from the base 24, it is also within the ambit of the present invention where the assembly 20 is mounted in other orientations, e.g., where the assembly 20 is mounted at an angle relative to vertical, or where the column is inverted. It is also possible for the column to be used with or without alternative couplings and/or mounting components, which might even be uniquely configured for use with a particular type of structure.

As mentioned previously, the illustrated assembly 20 includes a single jacking column assembly 22, but it is also consistent with the principles of the present invention where multiple jacking column assemblies 22 are stacked end-to-end. In particular, couplings with opposite male coupling ends can be inserted into outboard female ends of adjacent jacking column assemblies 22.

Turning to FIGS. 8 and 9, the jacking column assembly 22 further includes a clamp assembly 122, a speed drive 124, and a screw drive 126. The drives 124,126 (similar to drives discussed above) are preferably configured to be driven by a power tool with an electric or pneumatic motor, but could also be powered by a manual ratchet wrench or other wrench.

The clamp assembly 122 is configured to selectively frictionally interconnect the column sections 48,50 by compressing the outer column section 50 against the split bushing 98 and, in turn, compressing the split bushing 98 against the inner column section 48. The clamp assembly 122 includes opposite clamp arms 128 that each comprise a unitary plate with an elongated catch 130 at one end and a flange 132 at the other end. The flange 132 presents a stepped face 134 and holes 136,138 that intersect the face 134. The catch 130 is partly formed by an angled groove 140 that gives the catch 130 a hook-shaped cross-section end. The catch 130 is fixed to the flange 132 by a wall that offsets the catch 130 outwardly from the flange 132 along a direction normal to the face 134.

The hook end of the catch 130 is secured within a complemental groove presented by the corresponding rib 62. In addition, a flat inner face 142 of the catch 130 engages a flat outer face of the rib 62 to provide secure compressive engagement between the clamp arm 138 and the outer column section 50. Screws 144 extend through holes 136 in both catch arms 128 and are secured by nuts 146 to urge the flanges 132 toward each other. As the clamp assembly 122 is compressed, an axial slot 148 presented by the outer column section 50 adjacent the inboard end 52 permits arcuate end portions of the cylindrical wall 60 adjacent the axial slot 148 to deflect radially inwardly toward the split bushing 98. Because the axial slot 148 is generally axially aligned with slot 104 of bushing 98, the arcuate end portions of the wall 60 engage and deflect corresponding arcuate end portions of the split bushing 98 into the inner column section 48 to provide frictional engagement between the column sections 48,50. However, the principles of the present invention are applicable where the column assembly 22 is alternatively configured to provide relative frictional engagement between the column sections 48,50, e.g., where the column sections 48,50 are directly frictionally engaged by the clamp assembly 122, or where the clamp assembly 122 directly engages both of the column sections 48,50.

The clamp assembly 122 further includes a key 150 that presents a substantially rectangular shape with opposite edges 152,154 and a hole 156 that intersects edge 154. The key 150 is positioned between the flanges 132, with one of the screws 144 extending through the hole 156. The key 150 extends radially into and out of the axial slot 148, the slot 104, and the slot 90 to restrict relative rotational movement about the column axis between the column sections 48,50.

Turning to FIGS. 4-6 and 8, the speed drive 124 is coupled between column sections 48,50 to rapidly shift the column sections 48,50 relative to one another. In more detail, the speed drive 124 is preferably operable to shift the column sections 48,50 into an intermediate position that is close to a final secured position of the jacking column assembly 22 so that a relatively small amount of axial movement of the column sections 48,50 is required to bring the jacking column assembly 22 into the secured position. As will be discussed, movement from the intermediate position into the secured position results in application of a significant axial compressive force to the jacking column assembly. However, such movement may not be visually perceptible, or measurable, and may be close to zero in some instances.

The speed drive 124 preferably comprises a rack and pinion assembly with a toothed rack 158 and a rotatable pinion gear 160. The toothed rack 158 is secured within the slot 90 of inner column section 48. The illustrated pinion gear 160 is rotatably mounted to the clamp assembly 122. In particular, the speed drive 124 includes an input shaft 162 on which the gear 160 is mounted, bushings 164 that rotatably support the input shaft 162 within holes 138, and an adapter 166. In addition, the outer column section 50 and split bushing 98 present slot sections that project circumferentially from the respective slots 148,104. The slot sections serve as openings that provide spacing between the input shaft 162 and the corresponding column section 50 and split bushing 98.

The toothed rack 158 and pinion gear 160 intermesh with each other in the usual manner so that rotation of the gear 160 shifts the rack 158 and the inner column section 48 relative to the outer column section 50 and along the column axis. During use of the speed drive 124 and screw drive 126 to shift the column sections, the clamp assembly 122 is preferably tightened to a limited degree to prevent the column from retracting due to the weight of the tool and its own weight. However, the clamp assembly 122 is preferably tightened so that the clamp assembly 122 does not interfere with relative driving movement of the column sections by the drives 124,126. Preferably, the rack 158 and pinion gear 160 remain drivingly engaged (i.e., the speed drive 124 is engaged) as the column length is adjusted by the screw drive 126, but it is also within the scope of the present invention where the speed drive 124 can be disengaged when the screw drive 126 is engaged to adjust the column length. Furthermore, it is also possible to utilize other suitable speed drives (e.g., a linear actuator that is powered by a pressurized air or pneumatic source).

Turning to FIGS. 4-7 and 9, the screw drive 126 comprises another drive mechanism (in addition to the speed drive 124) for shifting the column sections 48,50 relative to each other. As will be discussed in greater detail, the screw drive 126 is configured to shift the column sections 48,50 from the intermediate position to the secured position in which the column length corresponds to fixed securement between surfaces of structure C and the column sections 48,50 carry substantial compressive axial loads. Furthermore, as will be shown, the screw drive 126 can be selectively disengaged to permit rapid shifting of the column sections 48,50 by the speed drive 124.

The screw drive 126 is generally housed within and is selectively drivingly connected between the column sections 48,50. The screw drive 126 includes a shiftable drive housing 168, a gear transmission 170, and a screw assembly 172, a journal sleeve 174, and a lock bolt 176. As will be discussed, the lock bolt 176 is selectively supported and secured by a lock bushing 178 of the inner column section 48.

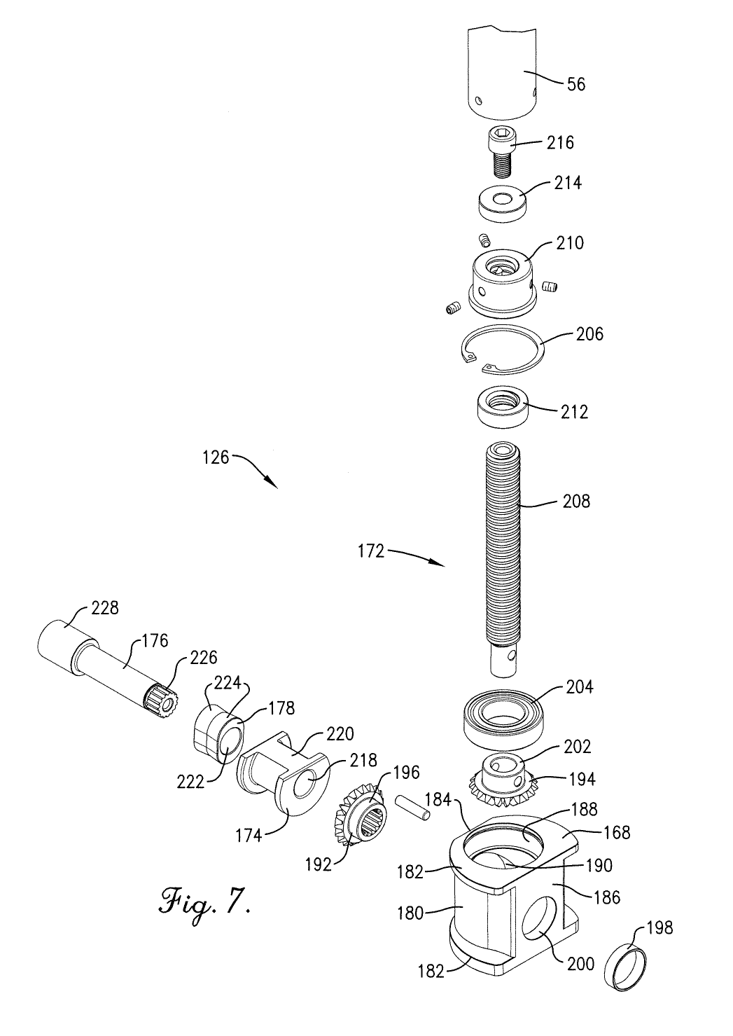

Turning to FIG. 7, the drive housing 168 is preferably unitary and includes a generally cylindrical body 180 with a body axis and flanges 182 on each end of the body 180. The drive housing 168 presents opposite flat forward and aft faces 184,186 that extend along the body axis. The drive housing 168 further presents an axial bore 188 that intersects an upper one of the flanges and a lateral bore 190 that intersects the forward face 184.

The gear transmission 170 includes input and output bevel gears 192,194. The input gear 192 includes beveled gear teeth and a neck 196 projecting from the gear, with the input gear 192 presenting a splined gear bore. The input gear 192 is rotatably supported by a bushing 198 within a bore 200 that intersects the aft face 186 (see FIG. 7). The output gear 194 includes beveled gear teeth and a neck 202 with a smooth gear bore and a transverse hole through the neck 202. The gear transmission 170 includes a bearing 204 mounted within the axial bore 188 and secured with a snap ring 206 that engages a circular slot in the axial bore 188. Thus, the bearing 204 is held between the snap ring 206 and a shoulder presented by the axial bore 188.

The neck 202 of the output gear 194 is rotatably received by the bearing 204 and is positioned so that the gears 192,194 drivingly intermesh with each other and are rotatably carried by the drive housing 168.

The screw assembly 172 includes a threaded shaft 208 and a threaded sleeve 210. The shaft 208 presents a smooth end and a threaded end, with threads extending continuously between the shaft ends. The threaded sleeve 210 presents a stepped outer surface, with a smaller end of the sleeve 210 being secured within an inboard end of the inner tube 56 (see FIG.6). The shaft 208 is threaded through the sleeve 210 so that the shaft 208 and outer column section 50 shift axially relative to one another as the shaft 208 is rotated. The shaft 208 is also attached to the output bevel gear 194 by inserting the smooth end into the neck 202 and securing a pin through the smooth end and the transverse hole in the output bevel gear 194.

A threaded backing sleeve 212 is mounted on the shaft 208 on the side of the bearing 204 opposite the output bevel gear 194. Thus, rotation of the shaft 208 causes relative axial shifting between the shaft and the outer column section 50, with the drive housing 168 and gear transmission 170 being axially fixed relative to the shaft 208. The screw assembly 172 also includes a washer 214 and fastener 216 that are attached to the threaded end of shaft 208 to restrict the shaft 208 from being threaded out of the sleeve 210, thereby limiting relative axial movement of the shaft 208.

The lock bolt 176 is removably attached to the gear transmission 170 and is supported by the journal sleeve 174 of the drive housing 168 and the lock bushing 178. As will be discussed, the lock bolt 176 is operable to drive the gear transmission 170 and thereby rotate the shaft 208 to selectively cause relative shifting of the column sections 48,50. The journal sleeve 174 presents a sleeve bore 218 and a flat face 220 that extends along the axis of the sleeve bore 218. The journal sleeve 174 is positioned within the drive housing 168, with the face 220 being positioned adjacent the output gear 194 and the sleeve bore 218 being substantially coaxial with the axis of the input gear 192.

Turning to FIGS. 6 and 7, the lock bushing 178 presents a bore 222 and outer tapered faces 224 with a generally elliptical shape that corresponds generally to the shape of oblong holes 88. The faces 224 taper inwardly from head ends of the lock bushing 178, and each face 224 presents a similar taper shape relative to the tapered inner face of the holes 88. The lock bushing 178 is dimensioned to selectively be received by any one of the holes 88. In particular, the inner face of holes 88 tapers to a minimum neck portion and the outer faces 224 taper from a maximum head portion (see FIG. 6), with the neck portion being oversized relative to the head portion to permit removal of the lock bushing 178 from the hole 88.

The lock bolt 176 includes a splined end 226 and a socket head 228 at an opposite end. The splined end 226 of lock bolt 176 is selectively inserted through the bore 222 of lock bushing 178, through the sleeve bore 218, and into the splined gear bore of the input gear 192. Consequently, the lock bolt 176 is supported to permit selective driving engagement with the input gear 192.

The illustrated screw drive 126 is configured to provide a robust and reliable mechanism for adjustable positioning the column sections 48,50. In particular, the threaded shaft 208 and sleeve 210 resist inadvertent collapse of the column due to static and dynamic axial loads (i.e., the shaft 208 and sleeve 210 do not easily turn relative to each other in response to static axial compression or axial vibration). Furthermore, the shaft 208 and sleeve 210 provide fine axial adjustment of the column length, and produce a significant mechanical advantage for overcoming large compression loads. However, the principles of the present invention are equally applicable where the column assembly 22 includes an alternative screw drive. For example, a worm gear could be used with a complemental gear section. Also, instead of the sleeve 210 with threads that extend continuously around shaft 208, the screw drive could include a threaded body with one or more discrete threaded segments that extend partly around the shaft 208. Moreover, the screw drive 126 could be configured with an alternative gear transmission, or could have an alternative transmission for powering the screw drive 126.

Turning again to FIGS. 4-6, the lock bolt 176 also serves to selectively transmit axial compression forces between the inner and outer column sections 48,50. In particular, when the lock bolt 176 is received through the bushing 178 and hole 88 and in the housing 168, axial forces can be transmitted from the outer column section 50, through the inner tube 56, along the screw assembly 17, drive housing 168, lock bolt 176, lock bushing 178, and to the inner column section 48. It is noted that the gear transmission 170 also carries some of the load, although it is not necessary.

The illustrated screw drive 126 is selectively engaged and disengaged by insertion of the lock bolt 176 and bushing 178. In other words, when the lock bolt 176 and bushing 178 are inserted to attach the screw drive 126 to the inner column section 48, the screw drive 126 is consequently engaged and is operable to shift the column sections relative to each other. Thus, removal of the lock bolt 176 and bushing 178 disengages the screw drive 126 and permits relative sliding movement between the drive housing 168 and the inner column section 48. The principles of the present invention are also applicable where an alternative mechanism is used to selectively engage the screw drive 126 (i.e., by connecting the screw drive to the inner column section 48). For example, an alternative locking device could be used to secure the housing 168 to the inner column section 48, or a clutch could be provided between inner tube 56 and sleeve 210.

While the lock bolt 176 transmits axial compression force through the column sections 48,50 (i.e., before, during, or after adjustment of the screw drive 126 to shift the column sections 48,50 into the secured position), the illustrated speed drive 124 remains engaged. Therefore, the pinion gear 160 will rotate along the rack, perhaps very slightly in some instances, as the screw drive 126 is operated. When the screw drive 126 has been adjusted to shift the column sections 48,50 into the secured position, the clamp assembly 122 can be further tightened to secure the column sections 48,50 and transmit axial compression forces between the inner column section 48 and outer column section 50. However, it is also within the scope of the present invention where the clamp assembly 122 transmits little or none of the axial forces carried by the jacking column assembly 22.

The column assembly 22 is selectively secured by rapidly shifting the column sections 48,50 with the speed drive 124 to the intermediate position (which is generally close to the final secured position), i.e., by rotating the pinion gear 160 to shift the toothed rack 158 and inner column section 48 axially relative to the outer column section 50. In the intermediate position, one of the locating holes is substantially aligned with the sleeve bore 218 to permit insertion of the lock bolt 176 and lock bushing 178. The inserted lock bolt 176 engages the gear transmission 170 and is rotated to shift the column sections 48,50 into the secured position where the column sections 48,50 carry the axial compressive load. The compressive load urges the lock bolt 176 to compress one side of the lock bushing 178 against the corresponding hole 88 (such contact being along the lower margin in FIG. 6). Because the tapered inner face of hole 88 and tapered outer face 224 converge in the radially outward direction, the compressive force applied to the lock bushing 178 by the lock bolt 176 urges the lock bushing into the drive housing 168 and thereby holds the lock bushing 178 within the hole 88.

In operation, the assembly 20 is secured to the structure C for cutting the hole H by first rapidly shifting the column sections 48,50 with the speed drive 124 to the intermediate position. The lock bolt 176 and lock bushing 178 are then inserted through a corresponding hole 88 that is aligned with the sleeve bore 218, and the inserted lock bolt 176 is drivingly attached to the gear transmission 170 to shift the column sections 48,50 into the secured position. With the jacking column assembly 22 secured to the structure C, the drill 44 can be shifted relative to the column sections 48,50 by moving the drill 44 along the column axis with the outer column drive 30 and/or by moving the drill along the transverse axis of the rail 32 with the transverse drive 40.

After the hole H has been completed, the drill 44 can be shifted to another hole location. Alternatively, the assembly 20 can be removed from the structure C by releasing axial compression on the jacking column assembly 22, i.e., by using the screw drive 126 to shift the column sections 48,50 toward each other until the compressive load on the columns is substantially removed. The screw drive 126 can then be disengaged (i.e., by removing the lock bolt 176 and lock bushing 178 from the inner column section 48, and also loosening the clamp assembly 122 if the clamp is frictionally engaging the column sections 48,50) to permit further relative shifting of the column sections 48,50 with the speed drive 124.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and access the reasonably fair scope of the present invention as pertains to any apparatus not materially departing from but outside the literal scope of the invention set forth in the following claims.

What is claimed is:

1. A jacking column for supporting a cutting or drilling tool between spaced apart surfaces, said jacking column comprising:
a pair of shiftably interconnected column sections that permit adjustment of the overall column length so that the column is fixedly securable between the surfaces;
a tool support operable to support a cutting or drilling tool at various positions along the length of the column;
a speed drive coupled between the column sections to rapidly shift the column sections relative to one another to an intermediate position; and
a selectively engageable screw drive configured to shift the column sections from the intermediate position to a secured position, in which the column length corresponds to fixed securement between the surfaces,
said screw drive being drivingly connected between the column sections to shift the column sections relative to one another when engaged,
said screw drive being drivingly disconnected from at least one of the column sections when disengaged so as to avoid interfering with relative shifting of the column sections by the speed drive,
said screw drive including a threaded shaft associated with one of the column sections and a threaded body associated with the other of the column sections, such that relative rotation of the shaft and body causes relative shifting of the column sections when the screw drive is engaged.

2. The jacking column as claimed in claim 1,
said column sections being telescopically interfitted.

3. The jacking column as claimed in claim 2,
said tool support including an elongated toothed rail fixed to the outer column section.

4. The jacking column as claimed in claim 2,
one of the column sections including an axially extending radial recess, with a radially extending key being fixed about the circumference of the other one of the column sections and received within the recess so as to restrict relative rotation between the column sections.

5. The jacking column as claimed in claim 1,
said speed drive comprising a rack and pinion assembly,
said rack and pinion assembly including an elongated toothed rack associated with one of the column sections and a rotatable pinion gear associated with the other of the column sections.

6. The jacking column as claimed in claim 4,
said rack and gear each being axially fixed relative to the associated column section, with intermeshing engagement of the rack and gear being maintained during shifting of the column sections by the screw drive.

7. The jacking column as claimed in claim 6,
said column sections being telescopically interfitted,
said one of the column sections including an axially extending radial recess in which the rack is located, with a radially extending key being fixed about the circumference of the other one of the column sections and received within the recess so as to restrict relative rotation between the column sections.

8. The jacking column as claimed in claim 1; and
a clamp assembly configured to provide an adjustable frictional connection between the column sections to variably restrain relative shifting of the column sections.

9. The jacking column as claimed in claim 8,
said column sections being telescopically interfitted, with the outer column section including an axially extending slot,
said clamp assembly including a split bushing interposed between the column sections in general axial alignment with the slot of the outer column section,
said clamp assembly including a clamp positioned around the outer column section in general axial alignment with the slot, with the clamp being configured to compress the outer column section against the bushing and thereby the bushing against the inner column section.

10. The jacking column as claimed in claim 9,
said clamp including a pair of clamp arms cooperatively extending at least partly around the outer column section and presenting spaced apart coupling sections that are interconnected by at least one adjustable fastener.

11. The jacking column as claimed in claim 10,
said speed drive comprising a rack and pinion assembly,
said rack and pinion assembly including an elonaged toothed rack associated with the inner column section and a rotatable pinion gear associated with the outer column section,
said clamp arms rotatably supporting the gear on the outer column section.

12. The jacking column as claimed in claim 11,
said inner column section including an axially extending radial recess in which the rack is located,
said clamp assembly including a radially extending key fixed about the circumference of the outer column section by the clamp arms and received within the recess so as to restrict relative rotation between the column sections.

13. The jacking column as claimed in claim 1,
said screw drive being releasably attached to said at least one of the column sections when the screw drive is engaged,
said at least one of the column sections being detached from the screw drive and thereby freely shiftable relative thereto when the screw drive is disengaged, such that the column sections are relatively shiftable by the speed drive without operating the screw drive when the screw drive is disengaged.

14. The jacking column as claimed in claim 13,
said screw drive including a lock bolt and a housing defining a bolt-receiving opening,
said at least one of the column sections including a plurality of axially spaced openings which are selectively brought into alignment with the bolt-receiving opening as the column sections are relatively shifted,
said lock bolt being removably received within the aligned openings of the screw drive and said at least one of the column sections to thereby axial fix the housing and said at least one of the column sections to one another and engage the screw drive.

15. The jacking column as claimed in claim 14,
each of said axially spaced openings of said at least one of the column sections being defined by a lock bushing removably received in a bushing-receiving hole,
said lock bushing presenting a bore through which the lock bolt extends,
said bushing-receiving hole being defined by a non-circular inner face,
said lock bushing presenting an outer face with a non-circular shape corresponding to that of the inner face so that relative rotational movement is prevented,
said faces being at least partly tapered in a radially outward direction relative to the axis of said at least one of the column sections, so that removal of the lock bushing from the bushing-receiving hole is restricted when the column sections are shifted to the secured position.

16. The jacking column as claimed in claim 15,
said faces of the bushing-receiving hole and lock bushing being tapered about their entire circumferences,
said inner face of the bushing-receiving hole tapering toward a minimum neck portion,
said outer face of the lock bushing tapering from a maximum head portion,
said neck portion being oversized relative to the head portion so that the lock bushing is removable from the bushing-receiving hole.

17. The jacking column as claimed in claim 14,
said housing including a journal sleeve that defines at least in part the bolt-receiving opening,
said journal sleeve rotatably receiving the lock bolt therein,
said screw drive including a gear transmission supported on the housing and drivingly interconnected between the lock bolt and one of the threaded shaft and body, such that rotation of the lock bolt operates the screw drive.

18. The jacking column as claimed in claim 17,
said threaded shaft being rotatably coupled to the housing and drivingly connected to the gear transmission so that rotation of the lock bolt causes rotation of the threaded shaft.

19. The jacking column as claimed in claim 18,
said screw drive including a support tube fixed to one of the column sections, with the axially spaced openings being defined in the other one of the column sections,
said body being fixed on the support tube.

20. The jacking column as claimed in claim 19,
said column sections being tubular and telescopically interfitted,
said threaded shaft, threaded body, housing, gear transmission, and support tube being located within the column sections.

21. The jacking column as claimed in claim 19, said body endlessly circumscribing the threaded shaft and presenting internal threads.
